(19) United States
(12) Patent Application Publication
(10) Pub. No.: US 2007/0127332 A1
(43) Pub. Date: Jun. 7, 2007

(54) Optical recording media

(75) Inventor: Fung-Hsu Wu, Taoyuan County (TW)

Correspondence Address: QUINTERO LAW OFFICE, PC, 2210 MAIN STREET, SUITE 200, SANTA MONICA, CA, 90405, US

(73) Assignee: DAXON TECHNOLOGY INC., TAOYUAN (TW)

(21) Appl. No.: 11/341,018

(22) Filed: Jan. 27, 2006

(30) Foreign Application Priority Data
Dec. 1, 2005 (TW) TW94142325

(51) Int. Cl. G11B 7/00; G11B 3/70

(52) U.S. Cl. 369/44.39; 369/283

(57) ABSTRACT

Optical recording media are provided. An optical recording medium for an optical pick-up unit includes a first substrate, a recording layer disposed on the first substrate, a second substrate, a thermo-sensitive layer disposed on the second substrate, a reflective layer disposed on the thermo-sensitive layer and an adhesive layer. The adhesive layer connects the reflective layer and the recording layer, such that the first and second substrates are fixed. When the optical pickup unit is in a recording mode, it emits a laser beam to the recording layer for data recording. When the optical pick-up unit switches from the recording mode to a labeling mode, the laser beam focuses on the reflective layer, and the thermo-sensitive layer is heated to change color thereof.

### BACKGROUND OF THE INVENTION

1. Field of the Invention

The invention relates in general to optical recording media and in particular to optical recording media capable of laser recording and labeling.

2. Description of the Related Art

Referring to FIG. 1, a conventional optical recording medium, such as a CD (compact disk) or DVD (digital versatile disk), comprises a data side D1 and a label side D2. An optical pick-up unit (OPU) reads or records digital data from the data side D1, and the user can write or print patterns on the label side D2.

However, it is usually laborious and difficult to form a complex pattern on the label side D2 by hand. Although the label can also be printed on the label side D2 by printers, it is too expensive to be widely applied.

### BRIEF SUMMARY OF THE INVENTION

Optical recording media are provided. An optical recording medium for an optical pick-up unit includes a first substrate, a recording layer disposed on the first substrate, a second substrate, a thermo-sensitive layer disposed on the second substrate, a reflective layer disposed on the thermo-sensitive layer and an adhesive layer. The adhesive layer bonds the reflective layer and the recording layer, such that the first and second substrates are fixed. When the optical pickup unit is in a recording mode, it emits a laser beam to the recording layer for data recording. When the optical pick-up unit switches from the recording mode to a labeling mode, the laser beam focuses on the reflective layer, and the thermo-sensitive layer is heated to change color thereof.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional optical recording medium;

FIG. 2 is a perspective diagram of an embodiment of an optical recording medium;

FIG. 3 is a large view of portion A in FIG. 2; and

FIG. 4 is a large view of portion B in FIG. 2.

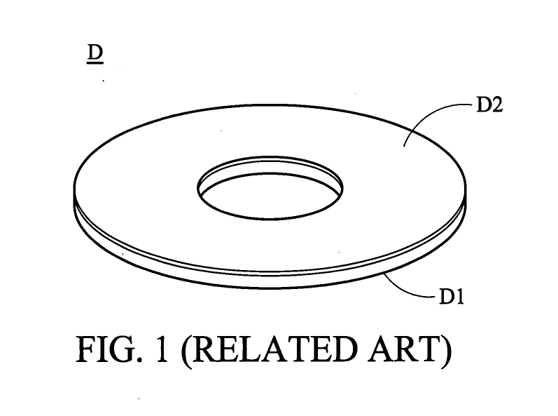

### DETAILED DESCRIPTION OF THE INVENTION

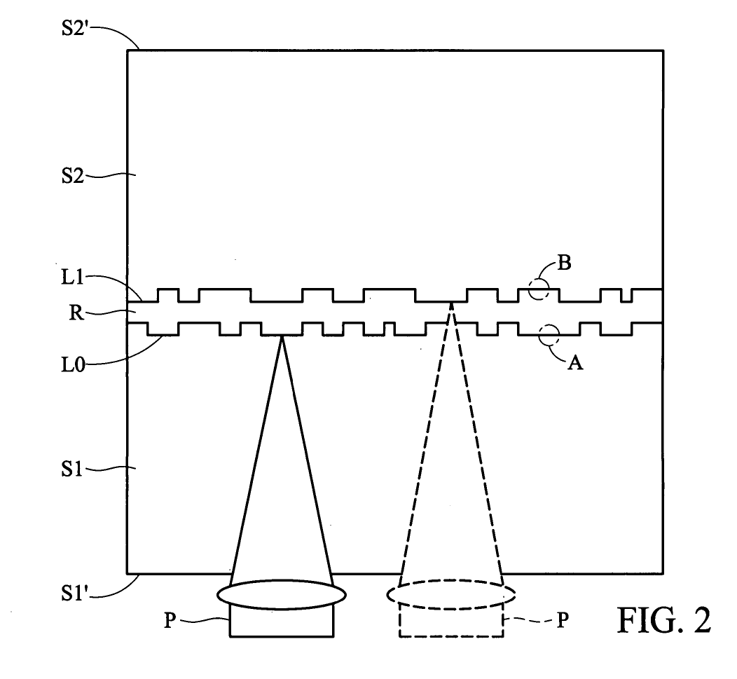

Referring to FIG. 2, an embodiment of an optical recording medium, such as a single side double layer (SS/DL) DVD-R, primarily comprises a first substrate S1, a recording layer L0, an adhesive layer R, a label layer L1 and a second substrate S2. An optical pick-up unit P can selectively focus a laser beam on the recording layer L0 or the label layer L1, to record data or form specific patterns on the optical recording medium, respectively. As shown in FIG. 2, both the recording layer L0 and the label layer L1 have land-groove structures, wherein the recording layer L0 is disposed on the first substrate S1, and the label layer L1 is disposed on the second substrate S2. The adhesive layer R connects the recording layer L0 and the label layer L1, such that the first and second substrates S1 and S2 are fixed. In some embodiments, the adhesive layer R comprises UV resin, and the first and second substrates S1 and S2 comprise Polycarbonate (PC).

Specifically, the optical pick-up unit P can read data, record data or label the disk by emitting a laser beam into the optical recording medium from a readout surface S1′ of the first substrate S1. According to this embodiment, only one optical pick-up unit P is required for recording and labeling processes, potentially reducing production costs. Moreover, it is not necessary to turn over the optical recording medium when switching between recording and labeling processes, facilitating convenience to users.

To record data in the optical recording medium when in a recording mode, the optical pick-up unit P focuses a laser beam on the recording layer L0. To label the optical recording medium, as the dashed line indicats in FIG. 2, the optical pick-up unit P is switched from recording mode to a labeling mode and focuses the laser beam on the label layer L1, to change color of a thermo-sensitive material therein. Since the first and second substrates S1 and S2 are transparent, patterns formed on the label layer L1 are visible from a label surface S2′ of the second substrate S2.

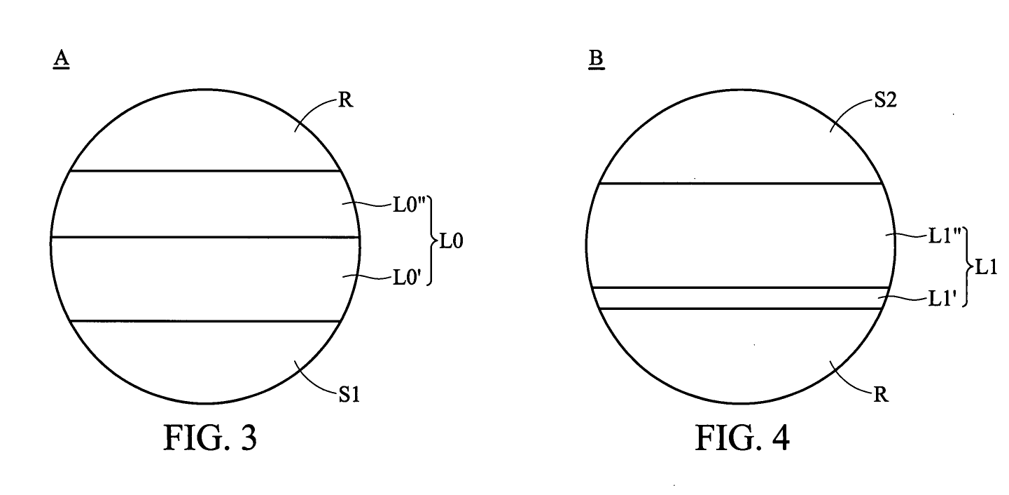

FIG. 3 is a large view of portion A in FIG. 2, wherein the recording layer L0 includes a dye layer L0′ and a semi-reflective layer L0″. As shown in FIG. 3, the dye layer L0′ is disposed on the first substrate S1, and the semi-reflective layer L0″ is disposed on the dye layer L0′. The adhesive layer R firmly connects the semi-reflective layer L0″ and the label layer L1. Specifically, when the optical pick-up unit P is in the recording mode, a laser beam focuses on the dye layer L0′ for data recording with a part of light reflected from the semi-reflective layer L0″, such that the optical pick-up unit P obtains address information. In some embodiments, the dye layer L0′ comprises cyanine dye with thickness of 20˜100 nm, and the semi-reflective layer L0″ comprises silver with thickness of 5˜30 nm.

FIG. 4 is a large view of portion B in FIG. 2, wherein the label layer L1 includes a reflective layer L1′ and a thermo-sensitive layer L1″. As shown in FIG. 3, the thermo-sensitive layer L1″ is disposed on the second substrate S2, and the reflective layer L1′ is disposed below the thermo-sensitive layer L1″. The adhesive layer R firmly connects the reflective layer L1′ and the semi-reflective layer L0″. Specifically, when the optical pick-up unit P is switched from the recording mode to the labeling mode, laser beam passes through the recording layer L0 and reaches the reflective layer L1′. Hence, the thermo-sensitive layer L1″ is heated by the laser and changes color thereof to form specific patterns. Moreover, light is reflected from the land-groove structures of the reflective layer L1′, such that the optical pick-up unit P can obtain address information, potentially facilitating accuracy of labeling. In some embodiments, the reflective layer L1′ comprises aluminum or silver alloy with thickness of 10˜100 nm, and the thermo-sensitive layer L1″0 comprises crystal violet lactone with thickness about 50 nm.

Optical recording media and methods of laser recording and labeling are provided according to the embodiments. An optical pick-up unit can record data or label an optical recording medium by focusing a laser beam on the recording layer or the label layer of the optical recording medium, respectively. In both the recording or labeling processes, the laser accesses the optical recording medium from the readout surface thereof, hence only one optical pick-up unit is required. Moreover, it is not necessary to turn over the optical recording medium when switching between recording and labeling processes, facilitating convenience to users.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical recording medium for an optical pick-up unit, comprising:
a first substrate;
a recording layer disposed on the first substrate;
a second substrate;
a thermo-sensitive layer disposed on the second substrate;
a reflective layer disposed on the thermo-sensitive layer; and
an adhesive layer connecting the reflective layer and the recording layer such that the first and second substrates are fixed, wherein the optical pick-up unit focuses a laser beam on the recording layer for data recording when in a recording mode, and when the optical pick-up unit switches from the recording mode to a labeling mode, the laser beam focuses on the reflective layer and heats the thermo-sensitive layer to change color thereof.

2. The optical recording medium as claimed in claim 1 further comprising a readout surface, wherein the laser beam reaches the reflective layer through the readout surface.

3. The optical recording medium as claimed in claim 1, wherein the reflective layer comprises a land-groove structure reflecting the laser beam to the optical pick-up unit, such that the optical pick-up unit obtains address information.

4. The optical recording medium as claimed in claim 1, wherein the reflective layer comprises aluminum oxide.

5. The optical recording medium as claimed in claim 4, wherein thickness of the reflective layer is 10˜100 nm.

6. The optical recording medium as claimed in claim 1, wherein the thermo-sensitive layer comprises crystal violet lactone (CVL).

7. The optical recording medium as claimed in claim 6, wherein thickness of the thermo-sensitive layer is about 50 nm.

8. The optical recording medium as claimed in claim 1, wherein the recording layer includes a dye layer disposed on the first substrate and a semi-reflective layer connecting the dye layer and the adhesive layer.

9. The optical recording medium as claimed in claim 8, wherein the dye layer comprises cyanine dye.

10. The optical recording medium as claimed in claim 8, wherein the semi-reflective layer comprises silver with thickness of 5˜30 nm.

11. A method of laser recording and labeling for an optical pick-up unit, comprising:
providing an optical recording medium comprising a recording layer, a reflective layer and a thermo-sensitive layer connected to the reflective layer;
focusing a laser from the optical pick-up unit on the recording layer for data recording; and
focusing the laser on the reflective layer, such that the thermo-sensitive layer is heated to form a pattern thereon.

12. The method as claimed in claim 11 further comprising a readout surface, wherein the laser beam reaches the reflective layer through the readout surface.

13. The method as claimed in claim 11, wherein the reflective layer comprises a land-groove structure reflecting the laser beam to the optical pick-up unit, such that the optical pick-up unit obtains an address information.

14. The method as claimed in claim 11, wherein the reflective layer comprises aluminum or silver alloy.

15. The method as claimed in claim 14, wherein thickness of the reflective layer is 10˜100 nm.

16. The method as claimed in claim 11, wherein the thermo-sensitive layer comprises crystal violet lactone (CVL).

17. The method as claimed in claim 16, wherein thickness of the thermo-sensitive layer is about 50 nm.

18. The method as claimed in claim 11, wherein the recording layer includes a dye layer disposed on the first substrate and a semi-reflective layer connecting the dye layer and the adhesive layer.

19. The method as claimed in claim 18, wherein the dye layer comprises cyanine dye.

20. The method as claimed in claim 18, wherein the semi-reflective layer comprises silver with thickness of 5˜30 nm.
